(19) United States
(12) Patent Application Publication
(10) Pub. No.: US 2017/0061362 A1
(43) Pub. Date: Mar. 2, 2017

(54) Methods and Systems for Workforce Resources and Workforce Capital Management

(71) Applicants: Milen Petkov Tzvetanov, Kew Gardens, NY (US); Varta Tchakarian Tzvetanov, Kew Gardens, NY (US)

(72) Inventors: Milen Petkov Tzvetanov, Kew Gardens, NY (US); Varta Tchakarian Tzvetanov, Kew Gardens, NY (US)

(21) Appl. No.: 14/833,145

(22) Filed: Aug. 24, 2015

(51) Int. Cl. G06Q 10/06; G06Q 10/10; B25J 11/00; B25J 9/16; B25J 9/00

(52) U.S. Cl. CPC G06Q 10/063118; B25J 9/1661; B25J 9/0084; B25J 11/0045; G06Q 10/105

(57) ABSTRACT

The invention provide methods for creating, implementing, and managing workforce resources and workforce capital.

Workforce resources are defined as the result of combining human resources' abilities such as persons' skills with Technology Resources features into a single entity with capabilities that are possible when Human Resources and Technical Resources are combined together.

The method provides the ability to define and assign Workforce resources with specific attributes that allow easy, effective, and efficient way of applying Workforce Resources into business processes.

The invention provides systems for organizing information about Workforce Resources and used as tool for sourcing business processes with required Workforce Resources.

### FIELD

The invention relates to methods and systems for managing workforce resources, and in particular using human resources and technical resources to define and manage productivity resources as part of operations and business processes.

### BACKGROUND

In organizations that produce value-added services or/and goods, employees work using Human Resources or/and Human Capital Management principles. In those models, people are defined as a labor unit of the process producing goods and/or services. Managing Employees is usually done by Human Resources (HR) or People departments of organizations. Employees' performance is used to measure productivity and set plans for improving existing or developing new skills. All these activities are also managed by HR/People departments

Such organizations would use various technology devices to improve the process of producing value-added goods/services. Technology devices could be classified in categories of wide spectrum from basic to high-tech. The latter would include high performing Information Technology Systems, Artificial Intelligence systems, Robotics systems.

High tech devices are integrated in the value added service/goods producing processes to improve quality, reduce cost, and increase productivity. Traditionally, the implementation of High Tech solutions is responsibilities of Technology departments of organizations.

### SUMMARY

Typical approach for implementing high tech solutions is to start with process assessment and transition partially or entirely existing processes into new process that include high-tech systems.

With this approach, the set objectives are achieved with multiple challenges that are also associated with additional costs:
Rapid change driven from outside the process instead of process organic improvement
Termination of employment for people who are not required in the new process
Decreased morale of employees as process improvement is with the expense of human resources
Creates fear from innovation because improvement will jeopardize employment status
Cost for managing the risk for adoption of the new process that could be completely rejected or not achieving the full potential of improvements

Overall, High-Tech systems are viewed as solutions for improving service and production processes by replacing and reducing human resources.

If human resources are closely connected to high-tech systems, and human resources skills are combined with the features of Robotics, Artificial Intelligence, and high-performing information systems that will create new kind of workforce resources—productivity units with valuable capabilities.

Defining Workforce resources with capabilities and attributes will allow their effective management and use in processes.

The invention provides methods and systems for Workforce Capital Management which allows entire organization, or subset, or subgroup of organization to implement high-tech systems such as High Performance Information systems, Artificial Intelligent systems, and Robotics systems in business processes and operations, by using workforce resources which are formed by combining employees' skills and technology features into a single productive entity.

The invention allows organizations to apply high-tech systems into operations with significantly reduced negative impact on human resources. This is achieved because human resources are initially enabled to enhance own capabilities by combining skills with robotics, Artificial Intelligence, or High-Performing information systems.

The invention provides systems to organize information about workforce resources and use the systems for sourcing solutions for supporting business goals and objectives.

One example to demonstrate the way workfare resources are used with the current invention in comparison to prior art is for improving operations of a Coffee shop.

Preparing coffee beverage could require rudimentary skills of filling cups with coffee from the coffee machines, or preparing complicated beverages such as espresso or Cappuccino, which requires more advanced skills of the trade.

Coffee shop is also in the business of serving customers by personnel whose friendly attitude could be critical factor for successful business.

Coffee shops operations are often staffed by eight people. Human Resources is also one of highest cost of coffee operations.

Driven by goal to stay competitive with cost, coffee shop owner might decide to reduce the number of human resources and implement Robotics systems, such as Baxter. Baxter is robotic system that is capable to perform rudimentary repeatable tasks in people safe manner.

Under prior art, Coffee shop owner will reduce number of employees and place Baxter robot to prepare coffee. For more complicated beverages, such as espresso and Cappuccino, the owner will replace traditional machines with automated machines in order to align with Baxter's limitation of performing only rudimentary repetitive tasks.

Automated espresso and Cappuccino machines however, reduce the quality of those beverages. That presents a challenge to maintaining higher price for those beverages.

As result of using the prior art, risk is present that the coffee shop will have lower quality of product, low morale of workforce, which results in reduced quality of customer service, and final outcome will be reduced revenue. Reduced level of revenue would completely eliminate the benefit of reduced cost the owner had sought by replacing human resources with robotics systems.

With the current invention, the coffee shop owner will create workforce resource by combining the skills of employees with Baxter's capabilities.

A workforce resource (Workforce Resource type A) will have own capabilities and attributes. For example, Workforce resource consisting of one employee and two Baxter robots will have the capability to conduct friendly interactions with customers, while Baxter is preparing simple coffee beverages.

Another Workforce resources (Workforce resource type B) consisting of Barista, a high quality espresso machine, and Baxter robot will allow preparing high quality espresso or cappuccino by Barista, while using Baxter to wash after beverage is prepared. Higher profitability and improved efficiency allow for applying two workforce resource of type B.

Third type Workforce Resource (Workforce resource type C) consists of one employee, with management, and administrative skills, who also is actively engaged at the point of sale.

Now operations are handled by four workforce resources—1 Workforce resource type A, 2 Workforce resources type B, 1 Workforce resource type C, that are defined by combining four employees and four robots.

Although net number of human resources and technical resource are the same under prior art and current invention, with the current invention, the business process is constructed by symbiotic resource with dedicated capabilities—better planning, better design, sustained high quality of more profitable products, and high quality of customer interactions.

Through automation, the productivity throughput rate had increased; quality level had sustained high, while cost is reduced.

Instead of just replacing some of the human resources with Baxter robots under prior art, coffee shop owner had used current inventions to create workforce resources and design better operational model.

Success of the new model where Workforce resources created with the current invention could motivate coffee shop owner to apply the model again and expand business operations to another location.

### DESCRIPTION OF DRAWINGS

FIG. 1 is a diagram showing simplified model of organizational elements under prior art

FIG. 2 is showing a simplified model of main attributes that are used to define and manage human resources and technology resources under prior art

FIG. 3 is showing a simplified model of main attributes that are used to define and manage workforce resources using the present invention

FIG. 4 is showing simplified model of organizational elements using current invention

FIG. 5 is showing simplified view of interaction between organizational elements under prior art

FIG. 6 is showing simplified view of interaction between organizational elements using current invention

FIG. 7 is showing simplified view of systems used for managing Human Resources and Technology Resources under prior art

FIG. 8 is showing simplified view of system for managing workforce resources with the current invention

FIG. 9 is showing example of sourcing business solutions with human resources and technology resources under prior art

FIG. 10 is showing example of sourcing business solutions with human resources and technology resources using current invention

### DETAILED DESCRIPTION

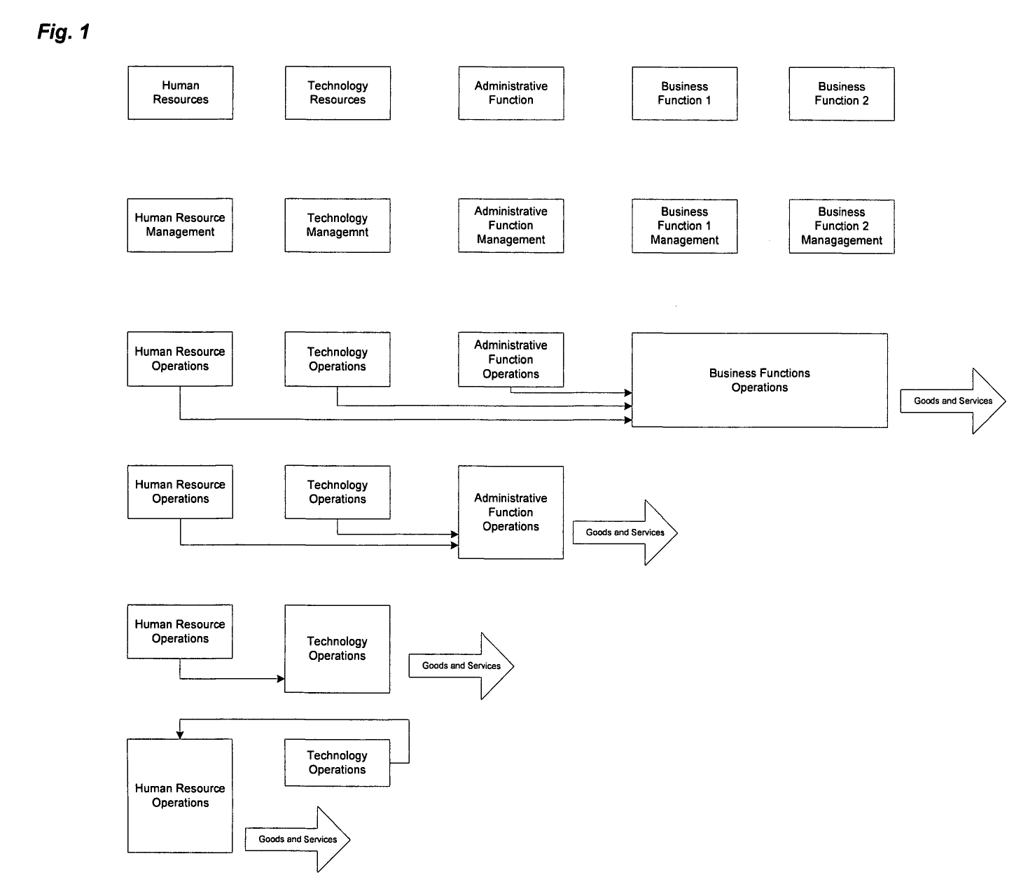

As shown on FIG. 1, a simple model of organizational elements of Organizational Functions segmented in departments, such as Human Resources, Technology Resources, Administrative Functions, such as Legal or Procurement, one or more Business Functions that conduct the core activities of the organization's business model.

Each function is managed though the mean of specific Functions Management processes and practices.

Each function is also connected with other functions as part of the operating model of the organization.

One Operating Model example under prior art consist of:
Business Functions operate by using goods and services that are produced by Human Resources, Technology Resources, and supported by Administrative Functions
Administrative Function operates by using goods and services that are produced by using Human Resources and Technology Resources to produce Administrative goods and services.
Technology Resources Function operates by using goods and services that are produced by Human Resources and Administrative functions to produce Technology goods and services. For simplifying the view only the goods and services flow from Human Resources function is shown.
Human Resources Function operates by using goods and services that are produced by Human Resources and Administrative functions to produce Human Resources goods and services. For simplifying the view only the goods and services flow from Information Technology function is shown.

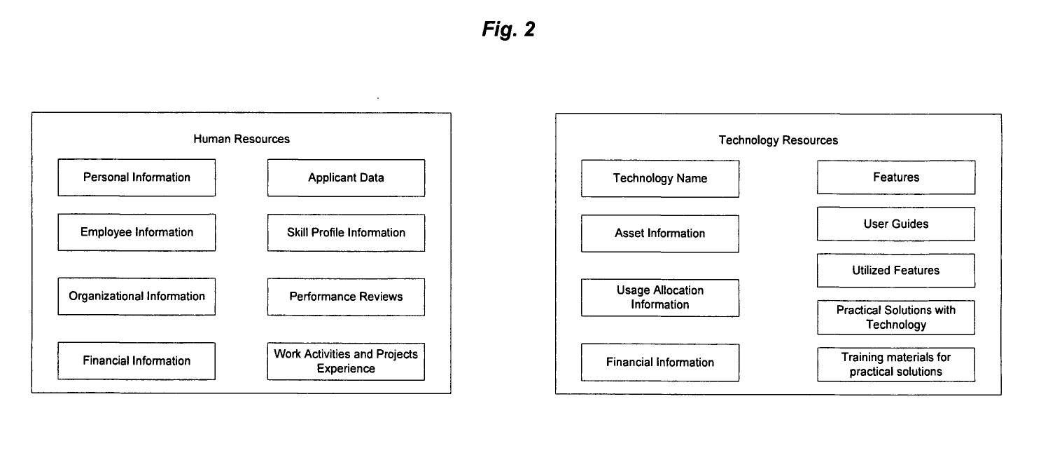

As shown in FIG. 2, under prior art, Human Resources and Technology resources are defined by set of attributes. In a simplified model, the main attributes that are used to define and manage human resources are:
Personal Information
Employee Information
Organizational Information
Financial Information
Applicant Data
Skill Profile Information
Performance Reviews
Work Activities and Project Experience
etc.

Complete list of attributes that are used to manage human resources will vary and depend of organizations business model, size, industry, geography, operational structure, strategic vision, etc.

The main attributes that are used to define and manage technology resources are:
Technology name
Asset information
Usage Allocation information
Financial Information
Features
User Guides
Utilized Features
Practical solutions where technology is applied
Training materials for practical solutions
etc.

Complete list of attributes that are used to manage technology resources will vary and depend of organizations' practices of technology and asset management.

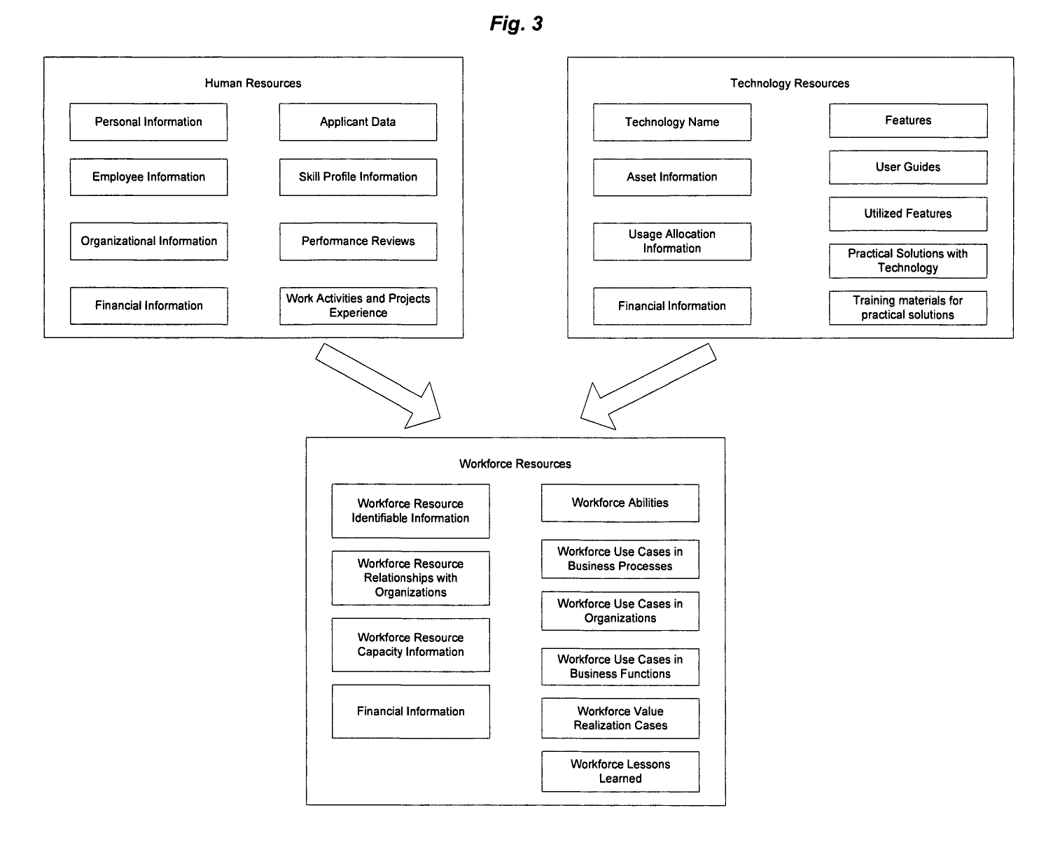

On FIG. 3 presents the current invention method where new productivity modules called Workforce Resources are created by combining human resources skills with technology features. The Workforce resources are also defined by own set of attributes:
Workforce Resource Identification information
Workforce Resource relationships with organizations
Workforce Resource capacity information
Financial information
Workforce abilities
Workforce use cases in business processes
Workforce use cases in organizations
Workforce use cases in business functions
Workforce value realization cases
Workforce Lessons Learned
etc.

Complete list of attributes that are used to manage Workforce resources will vary and depend of organizations' practices of Workforce Capital Management.

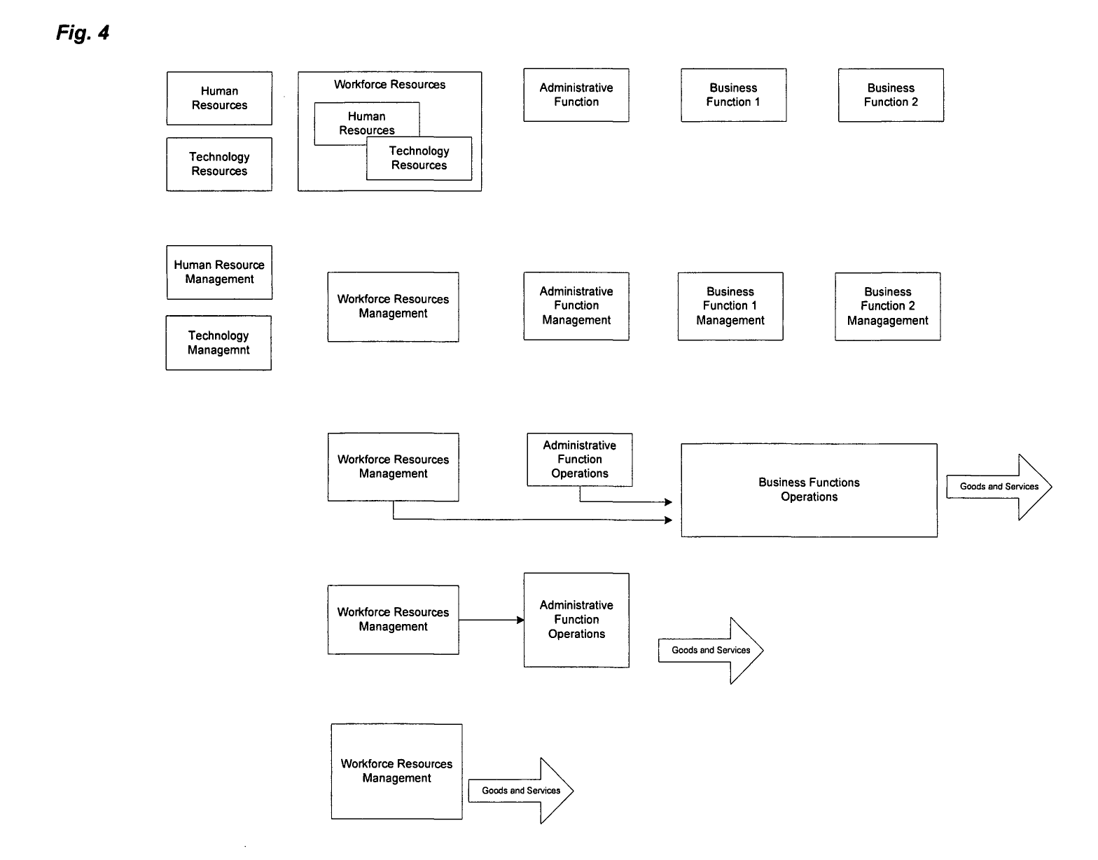

When current invention is implemented the organizational elements will differ in comparison of prior art. This is visually displayed in FIG. 4. It shows a new productivity entity, Workforce Resources. Workforce Resources takes place in the organizational and operational structure similar to other functions. It also is the direct result of combining the capabilities of Human resources and Technology resources and defining set of attributes for managing the Workforce resources.

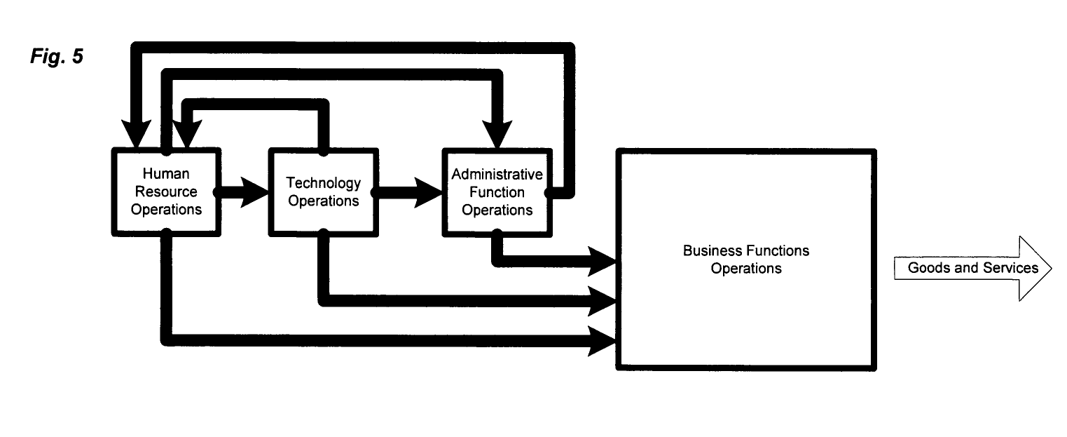

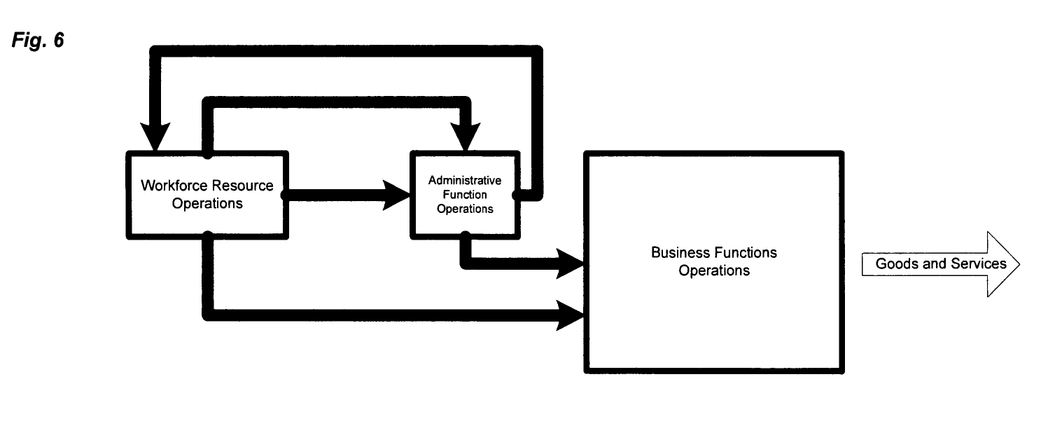

One of the advantages of applying this intention to define Workforce Resource function as part of the operating model is demonstrated in FIG. 5 and FIG. 6. FIG. 5 shows a simplified view of interaction between organizational functions under prior art and FIG. 6 shows a simplified view of interaction between organizational functions using current invention. A quick comparison shows how using Workforce function leads to simplified operational structure and interactions.

To support a practical implementation of the Workforce Resource method, the current invention provides a system to enable management of Workforce Resources.

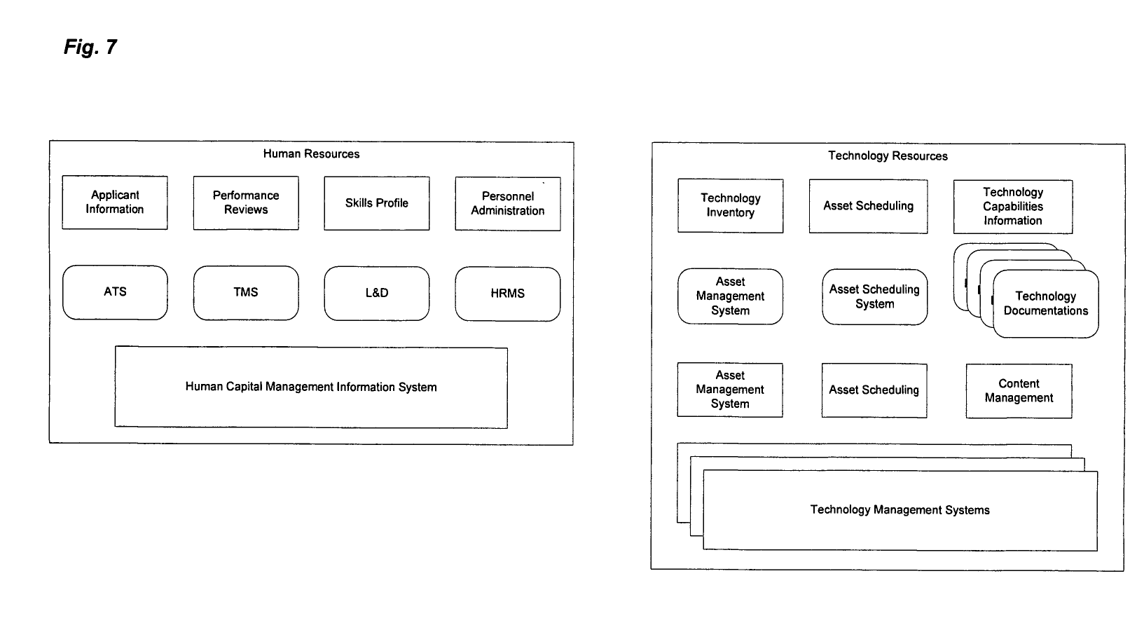

FIG. 7 shows simple model of systems used for managing human resources and technology resources respectively.

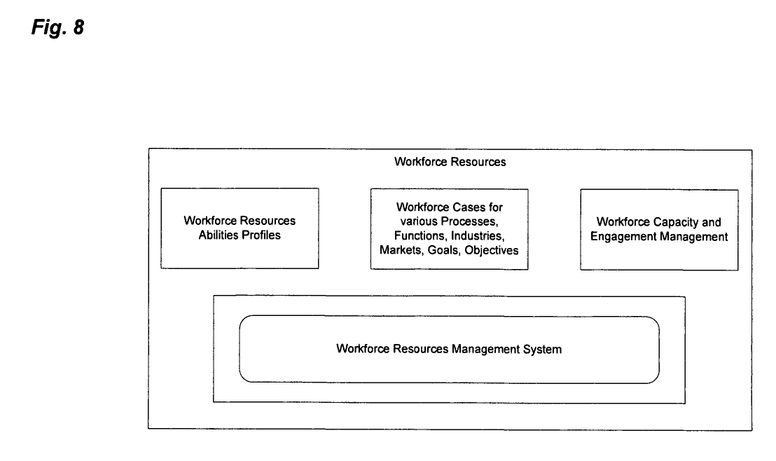

On FIG. 8 is shown a simplified view of system for managing Workforce resources information. This system is utilized for sourcing solutions with Workforce resources.

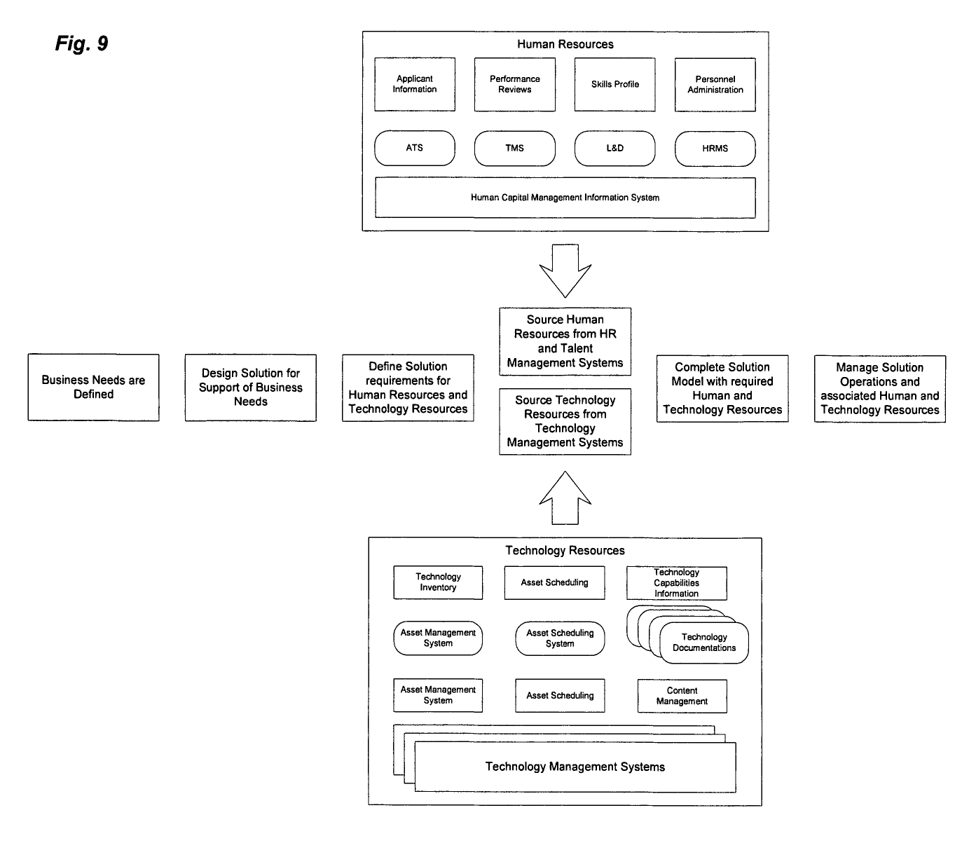

FIG. 9 shows simplified example of sourcing solution with human resources and technology resources. More specifically, when a business requirement is presented and solutions is designed to support the business need, under prior art, the solution is sourced with human resources by using Human Resource Management function and systems, and with technical resources by using Technology Management function and systems. Very often misalignments between human resources and technology resources occur that leads to negative impact on solution and reduced value.

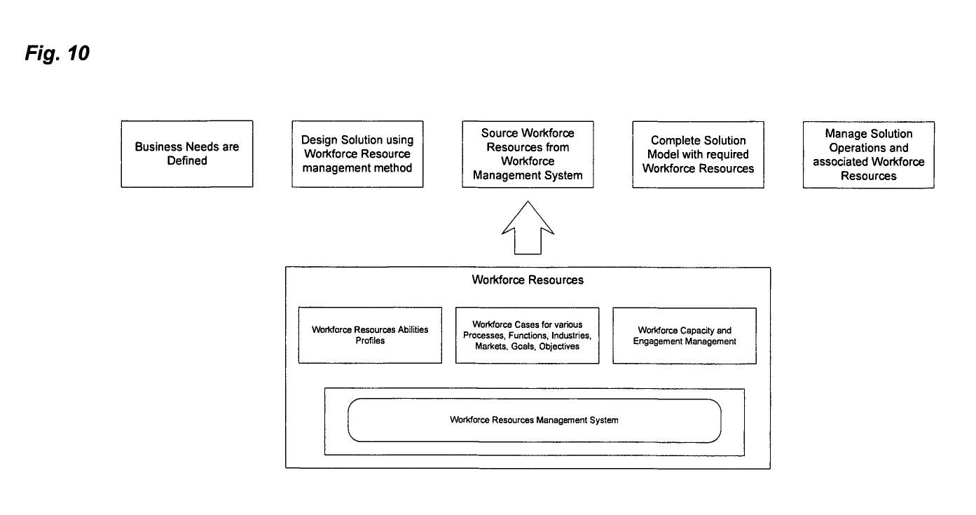

FIG. 10 shows a simplified model of using the current invention with Workforce Resource method where sourcing for solution is done by Workforce resource function and system. Because the human resource and technology resources alignment is built within the Workforce capabilities, sourcing the solution with best matching workforce resource is achieved with reduced negative risk.

Baxter© is a registered trade mark of RETHINK ROBOTICS, INC

1. The method for defining Workforce Resource as combining the abilities of human resources with the features of Robotics systems to build a single proactivity module with specific capabilities and attributes

2. The method for defining Workforce Resource as combining the abilities of human resources with the features of Artificial Intelligent systems to build a single proactivity module with specific capabilities and attributes

3. The method for defining Workforce Resource as combining the abilities of human resources with the features of high-performance information systems to build a single proactivity module with specific capabilities and attributes

4. The system of collecting and organizing information for Workforce resources as resulted in claim 1

5. The system of collecting and organizing information for Workforce resources as resulted in claim 2

6. The system of collecting and organizing information for Workforce resources as resulted in claim 3

7. Method for applying the result of claim 1 in solutions for supporting business processes and operations

8. Method for applying the result of claim 2 in solutions for supporting business processes and operations

9. Method for applying the result of claim 3 in solutions for supporting business processes and operations
